(19) United States
(12) Patent Application Publication
(10) Pub. No.: US 2006/0011035 A1
(43) Pub. Date: Jan. 19, 2006

(54) Portable punch device

(75) Inventor: William J. Schulz, Mosinee, WI (US)

Correspondence Address: FOLEY & LARDNER LLP, 321 NORTH CLARK STREET, SUITE 2800, CHICAGO, IL, 60610-4764, US

(73) Assignee: Fiskars Brands, Inc.

(21) Appl. No.: 10/890,939

(22) Filed: Jul. 14, 2004

(51) Int. Cl. B26D 5/08

(52) U.S. Cl. 83/523

(57) ABSTRACT

A punch device, comprising a lower housing and an upper housing pivotally connected to the lower housing. An impactor is positioned within the lower housing for selective action against a die, and at least one biasing member is positioned to bias the impactor towards the die. A lever arm selectively engaging the impactor and in contact with the upper housing. Actuation of upper housing causes the lever arm to move the impactor away from the die until the impactor disengages from the impactor and Upon disengagement, the impactor moves to towards the die so as to impart a force against the die.

### BACKGROUND OF THE INVENTION

The present invention relates generally to punch devices. More particularly, the present invention is related to portable punch devices for creating patterns in materials such as paper and cardstock.

A wide variety of mechanisms are conventionally known for cutting various shapes into materials such as paper, cardstock and vellum. For example, there are several hand held devices comprising a pair of handles and die members that permit a user to “punch” a design into a piece of material simply by squeezing the handles.

Although such devices are widely used, they suffer from a number of a significant drawbacks. For example, these devices often rely upon a proper alignment between mating die members to effectuate the punch. As a result, a relatively high level of tolerance is required during the manufacturing and assembly process, adding to the assembly costs. Additionally, such hand-held devices can require a high amount of force to punch a design in the materials to be manipulated. This can create difficulties for people such as the elderly and young children, who may have difficulty “squeezing” the handles together.

Furthermore, it is often desirable to punch different designs into a single sheet of material. Many conventional punches only include a single, permanent die set, which therefore would require a separate device for each design to be punched. Other devices, while permitting the user to remove and replace dies on the same device, possess a number of drawbacks of their own. In particular, replacement dies must be carefully inserted into the device while also maintaining the high degree of tolerance as described above. Therefore it often requires a significant amount of force both to remove a die already in the device and to insert a new die. The amount of force required can cause significant problems for many people such as children and the elderly.

Additionally, the above-described handheld punch devices also require the user to lift the material and place it between the mating die members in order to effectuate a punch. This can create difficulties in accurately locating the punch device on the material for the punch.

It would therefore be desirable to develop a portable punch device that overcomes the above difficulties while remaining easy to manipulate by virtually any users.

### SUMMARY OF THE INVENTION

It is therefore an object of the invention to provide an improved portable punch device that can be operated by a wide variety of users.

It is another object of the present invention to provide an improved portable punch device that permits a user to quickly and easily change the designs that are to be punched using the device.

It is still another object of the present invention to provide an improved portable punch device that enables a user to exert a higher level of force for the punching action than occurs using conventional punch devices.

It is yet another object of the present invention to provide an improved portable punch device that can be assembled with a lower degree of tolerance than conventional punch devices.

It is still another object of the present invention to provide an improved portable punch device that is relatively simple to manufacture.

It is finally another object of the present invention to provide an improved portable punch device that can be used on a wide variety of surfaces.

In accordance with the above objects, the present invention is directed to a punch assembly comprising a lower body and an upper body. An impactor is positioned within the lower body and is biased towards the material to be manipulated by at least one biasing member. A lever arm is rotatably coupled to the lower housing and is positioned to be in selective engagement with the impactor. A separate biasing member is used to bias the lever arm away from engagement with the impactor. When a user presses against the upper housing, the lever arm is rotated into engagement with the impactor, lifting the impactor away from a punch die and a die retainer, both of which are positioned below the impactor. At a predetermined distance, the lever arm disengages from the impactor. The impactor then impacts the punch die at a high force, causing the die to punch the die's design into the sheet of material.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a side view of a punch assembly constructed according to one embodiment of the present invention;

FIG. 2 is a front view of the punch assembly of FIG. 1;

FIG. 3 is a top view of the punch assembly of FIG. 1;

FIG. 4 is an exploded perspective view of the punch assembly of FIG. 1;

FIG. 5 is a side view of the punch assembly of FIG. 1 as the impactor is being released for subsequent contact with the die; and

FIG. 6 is a perspective exploded view of the die, die retainer and lower housing according to one embodiment of the present invention.

### DETAILED DESCRIPTION OF THE INVENTION

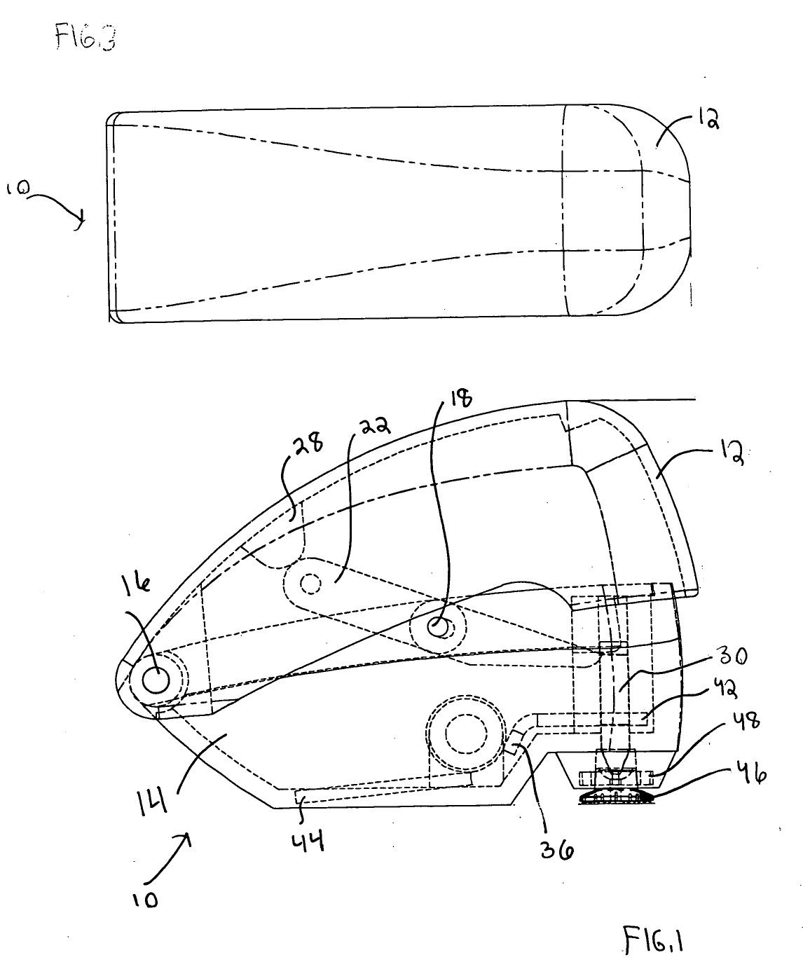

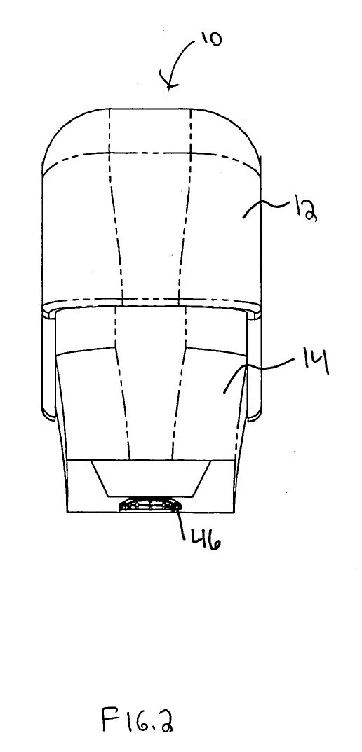

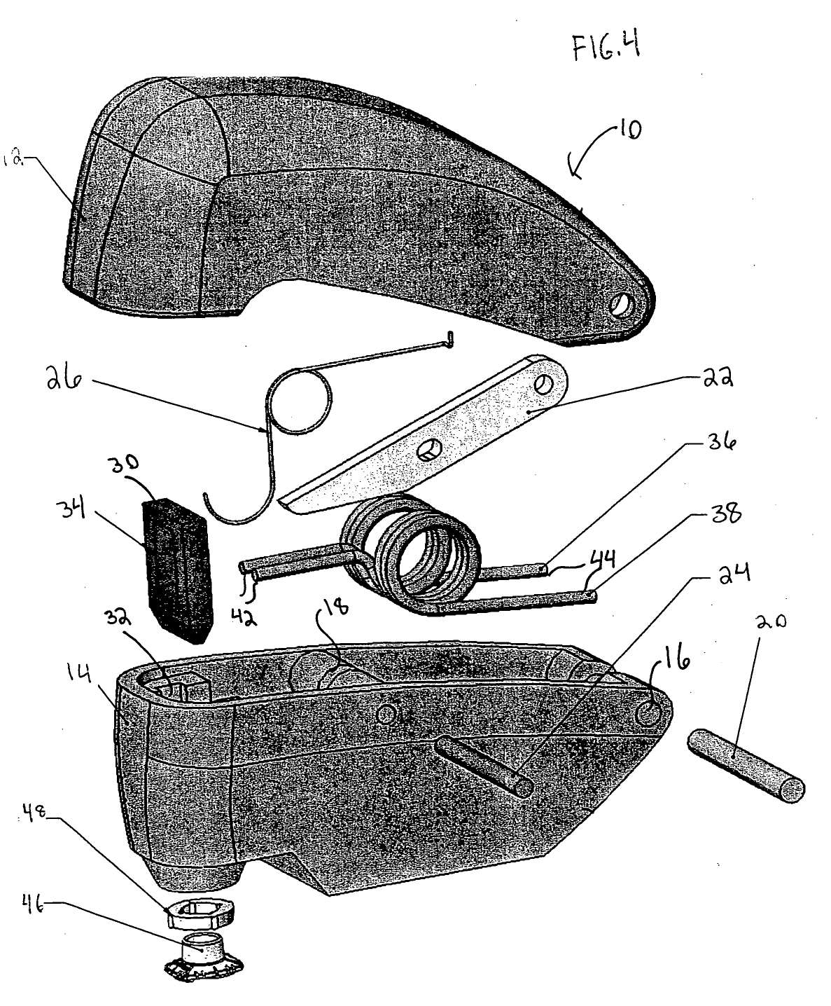

A punch assembly constructed according to the principles of the present invention is shown generally at 10 in FIGS. 1-5. The punch assembly 10, constructed according to one embodiment of the present invention, comprises an upper housing 12 and a lower housing 14. The lower housing 14 includes a rear pivot member 16 and an front pivot member 18. The upper housing 12 is coupled to the lower housing 14 at the rear pivot member 16 by a rear pivot pin 20. The rear pivot pin 20 permits the upper housing 12 to rotate relative to lower housing 14.

The punch assembly 10 includes a lever arm 22 that is rotatably coupled to the front pivot member 18 by a front pivot pen 24. The lever arm 22 is also operatively connected to a lever arm biasing member 26 which is positioned about the front pivot member 18. In the embodiment shown in FIGS. 1-5, the lever arm biasing member 26 comprises a coil spring. However, various other conventional biasing members may also be used. The rear end of the lever arm 22 contacts an abutment member 28 on the inside of the upper housing 12.

The lower housing 14 also includes an impactor 30 positioned within a slot 32. In the embodiment shown in FIGS. 1-5, the impactor 30 also includes an impactor opening 34 on the inside thereof. The lower housing 14 also includes first and second impactor biasing members 36 and 38 that are positioned around a transverse member 40 on the inside of the lower housing 14. In a preferred embodiment of the invention, the first and second impactor biasing members 36 and 38 comprise coil springs, although other well known biasing members could also be used. It is also possible to include a single impactor biasing member instead of the first and second impactor biasing members 36 and 38. Each of the first and second impactor biasing members 36 and 38 include a front end 42 and a rear end 44. The front end 42 of each of the first and second biasing members 36 and 38 acts against the impactor 30 by resting within the impactor opening 34, exerting a downward force against the impactor 30. The rear end 44 of each of the first and second impactor biasing members rest against and act against the inside of the lower housing 14.

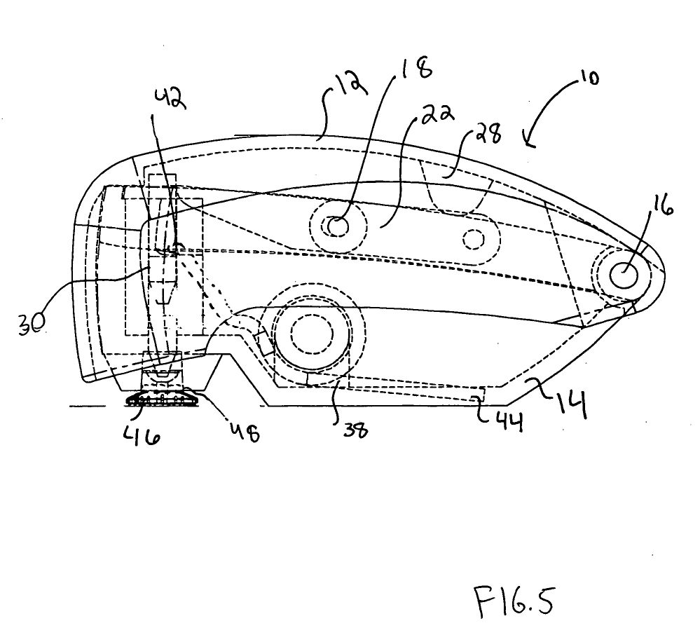

As is shown in FIG. 4, the punch assembly also includes a die 46 that is removably connected to the lower housing 14 via a die retainer 48. The die retainer 48, in one embodiment of the invention, comprises an o-ring. However, other retaining mechanisms could also be used. The die retainer 48 engages and holds the die 46 in place when the punch assembly 10 is and is not in use. When a user desires to remove the die 46 and replace it with another die, he or she simply manually pulls the die 46 out of the die retainer 48. Preferably, this can be accomplished without the use of external tools. The die 46 is similar to many conventional dies, including an outline of the design to be punched into the sheet of material.

In a preferred embodiment of the present invention and as shown in FIG. 6, the die 46, the die retainer 48 and a nose 54 of the lower housing 14 include a built-in mechanism for aiding in the alignment and the securing of the die 46 to the die retainer 48 and the die retainer 48 to the nose 54. In the embodiment shown in FIG. 6, the die 46 includes a plurality of die indexing ridges 50 about the periphery of the upper portion of the die 46. In a most preferred embodiment, the die indexing ridges 50 are positioned about every ninety degrees around the upper portion of the die 46, although other arrangements are possible. Corresponding inner die retainer indexing ridges 52 are similarly located about the inner surface 56 of the die retainer 48. The die indexing ridges 50 and the inner die retainer indexing ridges 52 are sized and positioned to allow the die 46 and the die retainer 48 to mateably engage with each other. The outer surface 58 of the die retainer 48 also includes a plurality of outer die retainer indexing ridges 60, which mateably engage corresponding nose ridges (not shown) on the inner surface of the nose 54 of the lower housing 14. The die indexing ridges, inner die retainer indexing ridges 50, the outer die retainer indexing ridges 60 and the nose ridges, both aid in securing the die 46 to the nose 54 as well as permit the user to easily and repeatedly align the die in one of a number of set locations relative to the rest of the punch assembly 10.

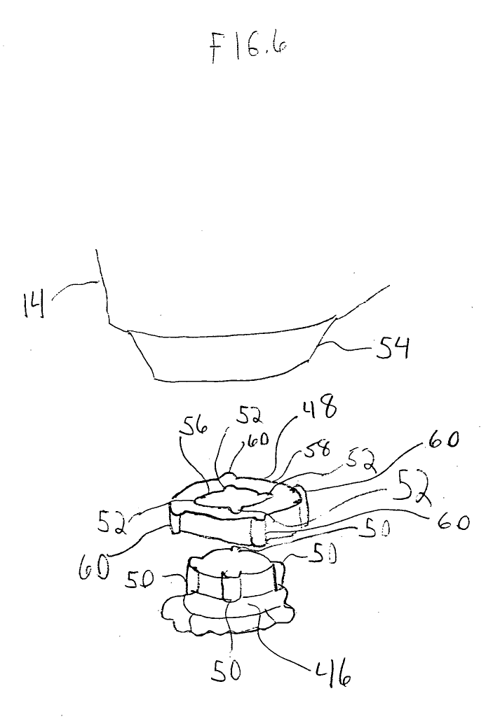

FIGS. 1 and 5 show the process by which material is punched according to one embodiment of the present invention. As is shown in FIG. 1, at rest, the front end of the lever arm 22 abuts against the top of the impactor 30 via the impactor opening 34. Furthermore and as previously discussed, the rear end of the lever arm 22 is positioned against the abutment member 28. When a user desires to punch a design into a sheet of material, he or she first places the punch assembly on the material to be manipulated. The user then presses down against the upper housing 12. This action causes the abutment member 28 to act against the rear end of the lever arm 22, causing the lever arm 22 to rotate about the front pivot pin 24. As a result of this rotation, the front end of the lever arm 22 acts in an upward manner against the impactor 30, causing the impactor 30 to move upward within the slot 32.

FIG. 5 shows the result of the user pressing against the upper housing 12, with the impactor 30 in a fully raised position. At this point, the front ends 42 of the first and second impactor biasing member 36 and 38 continue to act against the impactor 30 in an attempt to force the impactor 30 downward. At the point shown in the figure, the front end of the lever arm 22 has rotated to the point that it disengages from the impactor 30. At this point, the impactor 30 is released and is forced downward by the front end 42 of the first and second impactor biasing members 36 and 38, as well as by gravity. The impactor 30 then imparts a substantial force against the die 46, strongly and quickly forcing the die 46 against the material to be cut. The die 46 then punches its respective design into the material.

In one preferred embodiment of the invention, a cutting mat or similar material (not shown) is placed directly below the material to be punched by the punch assembly 10. The purpose of the cutting mat is to absorb the force imparted by the punch assembly 10 during the cutting process in order to prevent the underlying work surface, such as a table, from being damaged during the punching process.

After the cutting process has been completed, the user stops exerting pressure on the upper housing 12. The lever arm biasing member 26 then acts to place the lever arm 22 into its original position. As shown in FIG. 1, the lever arm 22 is capable of a slight degree of movement relative to the front pivot pen 24. This degree of movement permits the front end of the lever arm 22 to once again be positioned within the impactor opening 34 of the impactor 30.

The system and method of the present invention allows a user to quickly and efficiently impart a large amount of force on a die for the purpose of cutting a design into a sheet of material. The system can be used by users of varying ages, and also results in a very simple mechanism for replacing and/or exchanging the die from the punch assembly.

It should be understood that the above description of the invention and specific examples and embodiments, while indicating the preferred embodiments of the present invention, are given by demonstration and not limitation. For example, a variety of different types of biasing members could be used to bias the impactor and/or the lever arm of the punch assembly. Furthermore, it is also possible that the impactor would not come into actual contact with the die, but instead have forced transferred to the die through one or more intermediate components. Many changes and modifications within the scope of the present invention may therefore be made without departing from the spirit thereof and the present invention includes all such changes and modifications.

What is claimed is:

1. A punch device, comprising:
a lower housing
an upper housing pivotally connected to the lower housing;
an impactor positioned within the lower housing for selective action against a die;
at least one biasing member positioned to bias the impactor towards the die; and
a lever arm selectively engaging the impactor and in contact with the upper housing;
wherein actuation of upper housing causes the lever arm to move the impactor away from the die until the impactor disengages from the impactor and, upon disengagement, the impactor moves to towards the die.

2. The punch device of claim 1, wherein the at least one biasing member comprises first and second coil springs.

3. The punch device of claim 1, further comprising a lever arm biasing member operatively connected to the lever arm, the lever arm biasing member biasing the lever arm to a position where the lever arm does not attempt to move the impactor away from the die.

4. The punch device of claim 3, wherein the lever arm biasing member comprises a coil spring.

5. The punch device of claim 1, wherein the upper housing comprises an abutment member on the inside thereof for engagement with the lever arm.

6. The punch device of claim 1, wherein the die is removable from the punch device without the use of tools.

7. The punch device of claim 6, further comprising a die retainer for holding the die within the punch device.

8. The punch device of claim 7, wherein the die retainer includes at least one die retainer ridge on an inner surface thereof, and wherein the die includes at least one die ridge on a surface thereof for mateably engaging the at least one die retainer ridge.

9. The punch device of claim 1, wherein the lever arm is rotatable about a pivot pin positioned within the lower housing.

10. A punch assembly, comprising:
a first housing portion;
a second housing portion pivotally connected to the first housing portion;
an impactor positioned within the first housing portion for the selective application of force to a die;
means for biasing the impactor towards the die; and
a lever arm selectively engaging the impactor;
wherein actuation of the second housing portion causes the lever arm to move the impactor away from the die until the impactor disengages from the impactor and, upon disengagement, the impactor moves to towards the die to apply force to the die.

11. The punch assembly of claim 10, wherein the biasing means comprises at least one coil spring.

12. The punch assembly of claim 10, wherein the impactor includes an opening therein, and wherein the biasing means is partially positioned within the opening to bias the impactor towards the die.

13. The punch assembly of claim 12, wherein the lever arm selectively engages the impactor through the opening.

14. The punch assembly of claim 10, wherein the die is removable from the punch assembly without the use of tools.

15. The punch assembly of claim 10, further comprising lever arm biasing means for biasing the lever arm away from contact with the impactor.

16. The punch assembly of claim 15, wherein the lever arm biasing means comprises a coil spring.

17. A system for punching a sheet of material, comprising:
a lower housing;
an upper housing;
a pin for pivotally connecting the upper housing to the lower housing;
an impactor including an opening therein and positioned within the lower housing for selective action against a die;
at least one biasing member positioned partially within the opening to bias the impactor towards the die; and
a lever arm selectively engaging the impactor and in contact with the upper housing;
wherein actuation of upper housing causes the lever arm to move the impactor away from the die until the impactor disengages from the impactor and, upon disengagement, the impactor moves to impart a force on the die.

18. The system of claim 17, wherein the lever arm is rotatable about a pivot pin positioned within the lower housing.

19. The system of claim 18, further comprising lever arm biasing means for biasing the lever arm away from contact with the impactor.

20. The system of claim 17, wherein the die is removable from the punch assembly without the use of tools.

21. The system of claim 17, wherein the lever arm selectively engages the impactor through the opening.

22. The system of claim 17, further comprising a die retainer operatively connected to the lower housing, the die retainer mateably engaging the die.

23. The system of claim 22, wherein the die retainer includes at least one die retainer ridge on an inner surface thereof, and wherein the die includes at least one die ridge on a surface thereof for mateably engaging the at least one die retainer ridge.
